(19) United States
(12) Patent Application Publication
(10) Pub. No.: US 2016/0274832 A1
(43) Pub. Date: Sep. 22, 2016

(54) INFORMATION PROCESSING APPARATUS, PRINTING SYSTEM, AND INFORMATION PROCESSING METHOD

(71) Applicant: Noriko NISHIDA, Kanagawa (JP)

(72) Inventor: Noriko NISHIDA, Kanagawa (JP)

(73) Assignee: RICOH COMPANY, LTD., Tokyo (JP)

(21) Appl. No.: 15/063,729

(22) Filed: Mar. 8, 2016

(30) Foreign Application Priority Data
Mar. 18, 2015 (JP) 2015-055125

(51) Int. Cl. G06F 3/12; H04N 1/00

(52) U.S. Cl. CPC G06F 3/1219; H04N 1/00204; G06F 3/1204; G06F 3/1231; G06F 3/1239; G06F 3/1273; G06F 3/1288; H04N 2201/0094

(57) ABSTRACT

An information processing apparatus is for managing a usage amount of a function relating to image processing. The information processing apparatus includes a setting unit configured to set an upper limit value indicating an upper limit usage amount with respect to the function to be used within a predetermined period; a first storage unit configured to store a present value indicating a remaining usage amount obtained by subtracting the usage amount of using the function from the upper limit usage amount, when the function is used from when the upper limit value is set to when the predetermined period passes; and a present value increasing unit configured to increase the present value by an increase value indicating a predetermined usage amount, at a predetermined timing within the predetermined period.

### BACKGROUND OF THE INVENTION

1. Field of the Invention

The present invention relates to an information processing apparatus, a printing system, and an information processing method.

2. Description of the Related Art

Conventionally, a technology referred to as rule based print is known, which has a purpose of reducing the TCO (Total Cost of Ownership) of an image forming apparatus (see, for example, Patent Document 1). There has been demand for avoiding wasteful or excessing printing, that is, for printing efficiently without spending needless costs. Accordingly, rule based print reduces the TCO by changing the print settings based on print rules set in advance, printing up to (without exceeding) the upper limit usage amount (points) given to the user in advance, etc.

However, in the above conventional technology, there have been cases where efficient printing cannot be sufficiently performed. For example, in a system where the user can perform printing within the points given to the user in advance, there are cases where excessive points are given to the user, in order to prevent a situation of not being able to print the necessary pages because there are no more points. Thus, there are cases where the user performs unnecessary printing and the TCO is not sufficiently reduced.

In order to sufficiently reduce the TCO, it is preferable to cause the user to perform printing according to a plan so that the user does not perform unnecessary printing.

Patent Document 1: Japanese Laid-Open Patent Publication No. 2014-059742

### SUMMARY OF THE INVENTION

The present invention provides an information processing apparatus, a printing system, and an information processing method, in which one or more of the above-described disadvantages are eliminated.

According to an aspect of the present invention, there is provided an information processing apparatus for managing a usage amount of a function relating to image processing, the information processing apparatus including a setting unit configured to set an upper limit value indicating an upper limit usage amount with respect to the function to be used within a predetermined period; a first storage unit configured to store a present value indicating a remaining usage amount obtained by subtracting the usage amount of using the function from the upper limit usage amount, when the function is used from when the upper limit value is set to when the predetermined period passes; and a present value increasing unit configured to increase the present value by an increase value indicating a predetermined usage amount, at a predetermined timing within the predetermined period.

According to an aspect of the present invention, there is provided a printing system for providing a printing function, the printing system being connected via a network to a client terminal in which a user inputs a print job, the printing system including a setting unit configured to set an upper limit value indicating an upper limit usage amount with respect to the printing function to be used within a predetermined period; a first storage unit configured to store a present value indicating a remaining usage amount obtained by subtracting a usage amount of using the printing function from the upper limit usage amount, when the printing function is used from when the upper limit value is set to when the predetermined period passes; and a present value increasing unit configured to increase the present value by an increase value indicating a predetermined usage amount, at a predetermined timing within the predetermined period.

According to an aspect of the present invention, there is provided an information processing method used in a printing system for providing a printing function, the printing system being connected via a network to a client terminal in which a user inputs a print job, the printing system including a first storage unit configured to store a present value indicating a remaining usage amount obtained by subtracting a usage amount of using the printing function from an upper limit usage amount, when the printing function is used from when an upper limit value is set to when a predetermined period passes, the upper limit value indicating the upper limit usage amount with respect to the printing function to be used within the predetermined period, the information processing method including setting the upper limit value; and increasing the present value by an increase value indicating a predetermined usage amount, at a predetermined timing within the predetermined period.

### BRIEF DESCRIPTION OF THE DRAWINGS

Other objects, features and advantages of the present invention will become more apparent from the following detailed description when read in conjunction with the accompanying drawings, in which:

FIG. 1 illustrates a system configuration of an example of an upper limit management system according to a first embodiment;

FIG. 2 illustrates a hardware configuration of a computer according to the first embodiment;

FIG. 3 illustrates a hardware configuration of an example of an image forming apparatus according to the first embodiment;

FIG. 4 is a functional block diagram of an example of the upper limit management system according to the first embodiment;

FIG. 5 illustrates an example of a print job table;

FIG. 6 illustrates an example of an authentication information table;

FIG. 7 illustrates an example of a user point information table;

FIG. 8 illustrates an example of a consumption point information table;

FIG. 9 illustrates an example of an initial point information table;

FIG. 10 illustrates an example of a restore point information table;

FIG. 11 is a sequence diagram of an example of a series of processes relevant to function usage according to the first embodiment;

FIG. 12 is a flowchart of an example of a point restoring process according to the first embodiment;

FIG. 13 is a functional block diagram of an example of the upper limit management system according to second embodiment;

FIG. 14 illustrates an example of an initial point information table;

FIG. 15 illustrates an example of a usage time information table;

FIG. 16 is a sequence diagram of an example of a series of processes relevant to function usage according to the second embodiment;

FIG. 17 is a flowchart of an example of a point restoring process according to the second embodiment;

FIG. 18 is a functional block diagram of an example of the upper limit management system according to a third embodiment;

FIG. 19 illustrates another example of a user point information table;

FIG. 20 illustrates another example of an initial point information table;

FIG. 21 illustrates another example of a restore point information table; and

FIG. 22 is a sequence diagram of an example of a series of processes relevant to function usage according to the third embodiment.

### DETAILED DESCRIPTION OF THE PREFERRED EMBODIMENTS

Embodiments of the present invention will be described with reference to the accompanying drawings.

### First Embodiment

### System Configuration

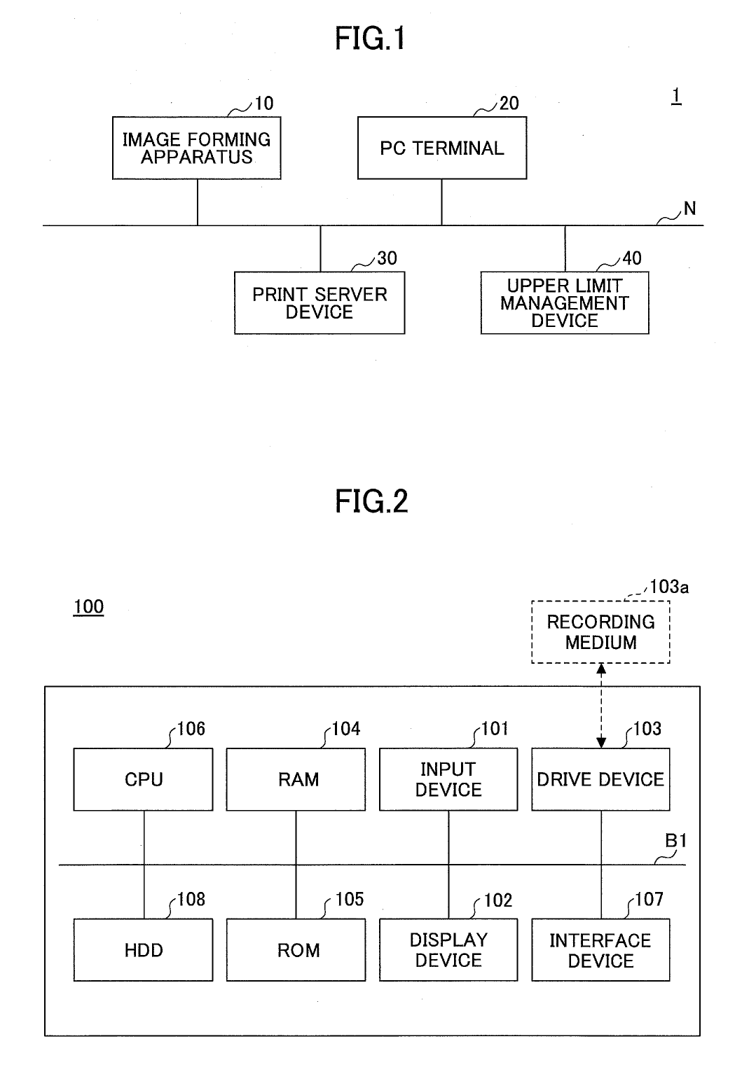

First, a system configuration of an upper limit management system 1 according to a first embodiment is described. FIG. 1 illustrates a system configuration of an example of an upper limit management system 1 according to the first embodiment. The upper limit management system 1 illustrated in FIG. 1 includes an image forming apparatus 10, a PC terminal 20, a print server device 30, and an upper limit management device 40, which are communicatively connected to each other via a network N. The network N is, for example, a LAN (Local Area Network), etc.

The image forming apparatus 10 is an image forming apparatus such as a printer that executes a print job stored in the print server device 30, according to a user's operation. However, the image forming apparatus 10 is not limited to a printer; for example, the image forming apparatus 10 may be various electronic devices such as a MFP (MultiFunction Peripheral), a scanner, a projector, an electronic blackboard, a digital signage panel, a game console, etc. That is, an embodiment of the present invention is applicable to a system including various electronic devices that execute a predetermined job and that perform processes as described below in cooperation with the upper limit management device 40.

The PC terminal 20 is a PC (personal computer) by which the user stores print jobs in the print server device 30, etc. The user can store a print job in the print server device 30 by making a print request from an application, etc., installed in the PC terminal 20.

The print server device 30 is a device that stores print jobs sent from the PC terminal 20 according to a user's operation. Furthermore, in response to a request from the image forming apparatus 10, the print server device 30 sends a print job relevant to the request, to the image forming apparatus 10.

The upper limit management device 40 is a device that implements upper limit management of print jobs executed by a user in the image forming apparatus 10.

Here, in the present embodiment, when the user executes a print job in the image forming apparatus 10, a point value according to the print setting, etc., of the print job is consumed. Therefore, a user desiring to execute a print job in the image forming apparatus 10 needs to execute the print job up to (without exceeding) a remaining point value that is the upper limit value, indicating the remaining point value of the user himself. That is, the upper limit management device 40 implements upper limit management by restricting the execution of a print job (for example, cancelling the printing) that exceeds the remaining point value, based on the remaining point value of the user, when the user uses a function of the image forming apparatus 10.

Furthermore, the upper limit management device 40 restores (increases) the remaining point value in units of predetermined amounts at every predetermined time interval.

Note that the configuration of the upper limit management system 1 is one example; the upper limit management system 1 is not limited to the above configuration. For example, the upper limit management system 1 may have a configuration in which some of or all of the functions of the print server device 30 and the upper limit management device 40 are included in the image forming apparatus 10. Furthermore, for example, the functions of the print server device 30 and the upper limit management device 40 may be included in one or more information processing apparatuses.

### <Hardware Configuration>

Next, a hardware configuration of the upper limit management system 1 according to the first embodiment is described.

<<PC Terminal, Print Server Device, Upper Limit Management Device>>

The PC terminal 20, the print server device 30, and the upper limit management device 40 according to the first embodiment are realized by a computer 100 having a hardware configuration as illustrated in FIG. 2, for example. FIG. 2 illustrates a hardware configuration of a computer 100 according to the first embodiment.

A computer 100 illustrated in FIG. 2 includes an input device 101, a display device 102, a drive device 103, and a RAM (Random-Access Memory) 104. Furthermore, the computer 100 includes a ROM (Read Only Memory) 105, a CPU (Central Processing Unit) 106, an interface device 107, and a HDD (Hard Disk Drive) 108. These hardware elements are interconnected by a bus B1.

The input device 101 includes a keyboard, a mouse, etc., and is used by the user for inputting various operation signals to the computer 100. The display device 102 includes a display, etc., and displays processing results obtained by the computer 100. Note that the input device 101 and/or the display device 102 may have a configuration of being connected to the computer 100 and used when necessary.

The interface device 107 is an interface that connects the computer 100 to the network N. Accordingly, the computer 100 is able to perform data communication with other devices via the communication I/F 107.

Furthermore, the HDD 108 is an example of a non-volatile storage device for storing programs and data. The stored programs and data include an OS (Operating System) that controls the entire computer 100, application software for providing various functions in the OS, programs for implementing various processes of the present embodiment, etc.

The HDD 108 manages the stored programs and data by a predetermined file system and/or a DB (database). Note that the computer 100 may include a storage device such as a Solid State Drive (SSD) instead of the HRDD or in addition to the HDD.

The drive device 103 is an interface with respect to a removable recording medium 103a, etc. Accordingly, the computer 100 is able to read and/or write in the recording medium 103a via the drive device 103. Examples of the recording medium 103a are a flexible disk, a CD, a DVD (Digital Versatile Disk), a SD memory card, USB memory (Universal Serial Bus memory), etc.

The ROM 105 is a non-volatile semiconductor memory (storage device) that can store programs and data even after the power is turned off. The ROM 105 stores programs and data such as a BIOS (Basic Input/Output System) that is executed when the computer 100 is activated, OS settings, network settings, etc. The RAM 104 is a volatile semiconductor memory (storage device) for temporarily storing programs and data.

The CPU 106 is an arithmetic device for controlling the entire computer 100 and realizing functions of the computer 100, by loading the programs and data from the storage devices such as the ROM 105 and the HDD 108, into the RAM 104, and executing processes.

The PC terminal 20, the print server device 30, and the upper limit management device 40 according to the present embodiment are able to realize various processes described below, by the hardware configuration of the computer 100 described above.

<<Image Forming Apparatus>>

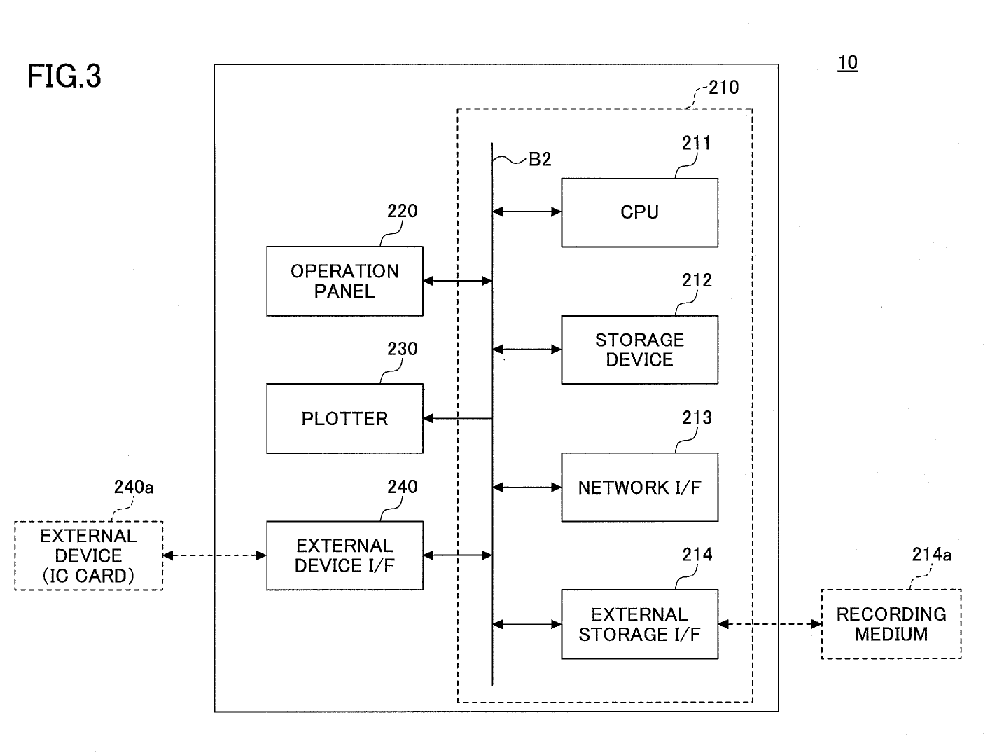

The image forming apparatus 10 according to the first embodiment is realized by a hardware configuration as illustrated in FIG. 3, for example. FIG. 3 illustrates a hardware configuration of an example of the image forming apparatus 10 according to the first embodiment. The image forming apparatus 10 illustrated in FIG. 3 includes a controller 210, an operation panel 220, a plotter 230, and an external device I/F 240, which are connected to each other via a bus B2.

The operation panel 220 includes a display unit and an input unit such as a touch panel. The operation panel 220 provides various kinds of information of the image forming apparatus 10 to the user, and receives various user operations such as operation settings, operation instructions, etc.

The plotter 230 includes an image forming unit, and forms output images on sheets. The method of forming an output image is, for example, an electrophotographic method, an inkjet method, etc. The external device I/F 240 is an interface for reading storage information from an external device 240a. The external device 240a is, for example, a non-contact IC (Integrated Circuit) card such as a smart card, etc. For example, the external device I/F 240 can use RFID (Radio Frequency Identification), etc., to read information such as ID information (card ID) stored in the external device 240a.

The controller 210 includes a CPU 211, a storage device 212, a network I/F 213, and an external storage I/F 214.

The CPU 211 implements various functions and controls the entire image forming apparatus 10, by executing programs. The storage device 212 stores and holds the above programs and various kinds of data (for example, image data). The storage device 212 is, for example, a RAM that is a volatile memory, a ROM that is a non-volatile memory, a HDD including a high-volume storage area, etc. The RAM functions as a work area (a storage area where programs and data are temporarily loaded) of the CPU 211. The ROM and the HDD are used as storage destinations of programs and various kinds of data. Accordingly, in the image forming apparatus 10, the CPU 211 loads the programs stored in the ROM into the RAM, and executes the programs.

The network I/F 213 is an interface for connecting the image forming apparatus 10 to the network N. Accordingly, the image forming apparatus 10 can perform data communication with other devices via the network I/F 213.

The external storage I/F 214 is an interface for connecting a recording medium 214a that is an external storage. Accordingly, the image forming apparatus 10 is able to read and/or write in the recording medium 214a via the external storage I/F 214.

The image forming apparatus 10 according to the present embodiment is able to realize various processes described below, by the above hardware configuration. Note that in the above example, the image forming apparatus 10 is a printer; however, when the image forming apparatus 10 is, for example, an MFP, etc., the image forming apparatus 10 includes a scanner, etc., that optically reads an original document and generates an image that has been read.

### <Functional Configuration>

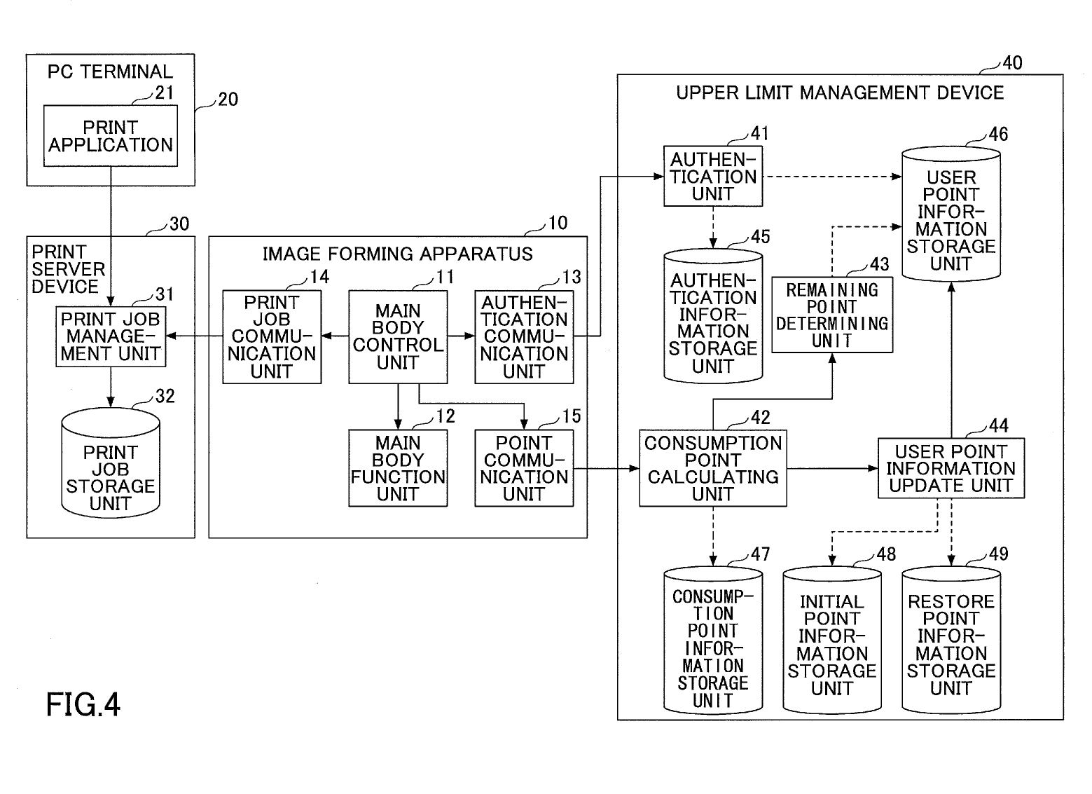

Next, a functional configuration of the upper limit management system 1 according to the first embodiment is described. The upper limit management system 1 according to the first embodiment is realized by, for example, the functional blocks as illustrated in FIG. 4. FIG. 4 is a functional block diagram of an example of the upper limit management system 1 according to the first embodiment.

<<PC Terminal>>

The PC terminal 20 includes a print application 21. The print application 21 generates a print job according to an operation relevant to a print request by the user, and sends the print job to the print server device 30. The print application 21 is, for example, a program capable of an operation relevant to the print request by the user, such as a web browser, document creating software, an image viewer, etc.

<<Print Server Device>>

The print server device 30 includes a print job management unit 31. Furthermore, the print server device 30 includes a print job storage unit 32.

The print job management unit 31 is realized by, for example, the CPU 106, etc., and causes the print job storage unit 32 to store a print job received from the PC terminal 20. Furthermore, the print job management unit 31 acquires, from the print job storage unit 32, a print job, etc., relevant to a request, in response to a request from the image forming apparatus 10, and sends the print job to the image forming apparatus 10 that is the request source.

The print job storage unit 32 is realized by for example, the HDD 108 or a storage device, etc., connected via the print server device 30 and a network, and stores a print job table 32D storing a print job received from the PC terminal 20.

For example, as illustrated in FIG. 5, the print job table 32D includes data items of a job ID that uniquely identifies a print job, a user ID that uniquely identifies a user who has performed an operation relevant to a print request, print target data indicating a file, etc., that is the print target, a print setting that is specified with respect to the print target data by the user, a print setting dynamically set by the device, etc. As described above, the print job table 32D stores a print job that is generated by and sent from the print application 21 of the PC terminal 20. Note that the print job table 32D may include, for example, a data item such as the time when the operation relevant to the print request has been performed (that is, the time when the print job has been generated), etc.

<<Image Forming Apparatus>>

The image forming apparatus 10 includes a main body control unit 11, a main body function unit 12, an authentication communication unit 13, a print job communication unit 14, and a point communication unit 15.

The main body control unit 11 is realized by, for example, the CPU 211, and requests each function unit to perform a process according to an operation made to the operation panel 220 by the user, a request from another function unit, etc. For example, the main body control unit 11 requests the authentication communication unit 13 to perform a process relevant to authentication, according to a login request operation by the user. Furthermore, for example, the main body control unit 11 requests the main body function unit 12 to execute a print job, according to an instruction operation for print execution by the user.

The main body function unit 12 is realized by, for example, the CPU 211, the plotter 230, etc., and executes a print function in response to a request from the main body control unit 11. That is, the main body function unit 12 executes a print job relevant to an instruction operation for print execution by the user. Note that when the image forming apparatus 10 is, for example, an MFP, etc., the main body function unit 12 may execute various functions such as a copy function, a scanning function, a fax function, etc.

The authentication communication unit 13 is realized by, for example, the CPU 211, the network I/F 213, etc., and sends an authentication request to an authentication unit 41 of the upper limit management device 40, in response to a request from the main body control unit 11.

The print job communication unit 14 is realized by, for example, the CPU 211, the network I/F 213, etc., and sends a request to acquire a list of print jobs that the user can execute, to the print job management unit 31 of the print server device 30, in response to a request from the main body control unit 11. Furthermore, the print job communication unit 14 sends a request to acquire a print job selected by the user from the list of print jobs. The point communication unit 15 is realized by, for example, the CPU 211, the network I/F 213, etc., and requests a consumption point calculating unit 42 of the upper limit management device 40 to calculate a point value to be consumed according to the execution of a point job, in response to a request from the main body control unit 11.

Furthermore, the point communication unit 15 sends a request to update the remaining point value of the user who has executed the print job, in response to a request from the main body control unit 11.

<<Upper Limit Management Device>>

The upper limit management device 40 includes an authentication unit 41, a consumption point calculating unit 42, a remaining point determining unit 43, and a point information update unit 44. Furthermore, the upper limit management device 40 uses an authentication information storage unit 45, a user point information storage unit 46, a consumption point information storage unit 47, an initial point information storage unit 48, and a restore point information storage unit 49.

The authentication unit 41 is realized by, for example, the CPU 106, etc., and refers to the authentication information storage unit 45 and performs authentication, based on an authentication request received from the authentication communication unit 13 of the image forming apparatus 10. Furthermore, the authentication unit 41 determines whether the remaining point value of the user relevant to the authentication request is not “0”, when performing the authentication.

The consumption point calculating unit 42 is realized by, for example, the CPU 106, etc., and refers to the consumption point information storage unit 47 to calculate a point value (consumption point value) that is consumed according to the execution of a print job, in response to a request from the point communication unit 15 of the image forming apparatus 10.

The remaining point determining unit 43 is realized by, for example, the CPU 106, etc., and determines whether the consumption point value calculated by the consumption point calculating unit 42 exceeds the remaining point value of the user.

The point information update unit 44 is realized by, for example, the CPU 106, etc., and updates the remaining point value of the corresponding user, based on the calculated consumption point value, in response to a request from the consumption point calculating unit 42.

Furthermore, the point information update unit 44 restores (increases) the remaining point value of the user, by referring to the restore point information storage unit 49, at every predetermined time interval (in the present embodiment, at every hour). That is, for each user, an initial point value, which indicates the initial value of the remaining point value, is set in advance according to the job type of the user. When the remaining point value of the user is less than an initial point value, the remaining point value is restored in units of predetermined point values at every hour (that is, for each user, the remaining point value is increased at every hour, up to (without exceeding) the initial point value that is the upper limit value). As described above, by restoring the remaining point value in units of predetermined point values at every predetermined time interval, the user can perform printing according to a plan, by foreseeing the point values to be restored.

The authentication information storage unit 45 is realized by, for example, the HDD 108 or a storage device, etc., connected via the upper limit management device 40 and a network, and stores an authentication information table 45D that is referred to by the authentication unit 41 at the time of performing authentication.

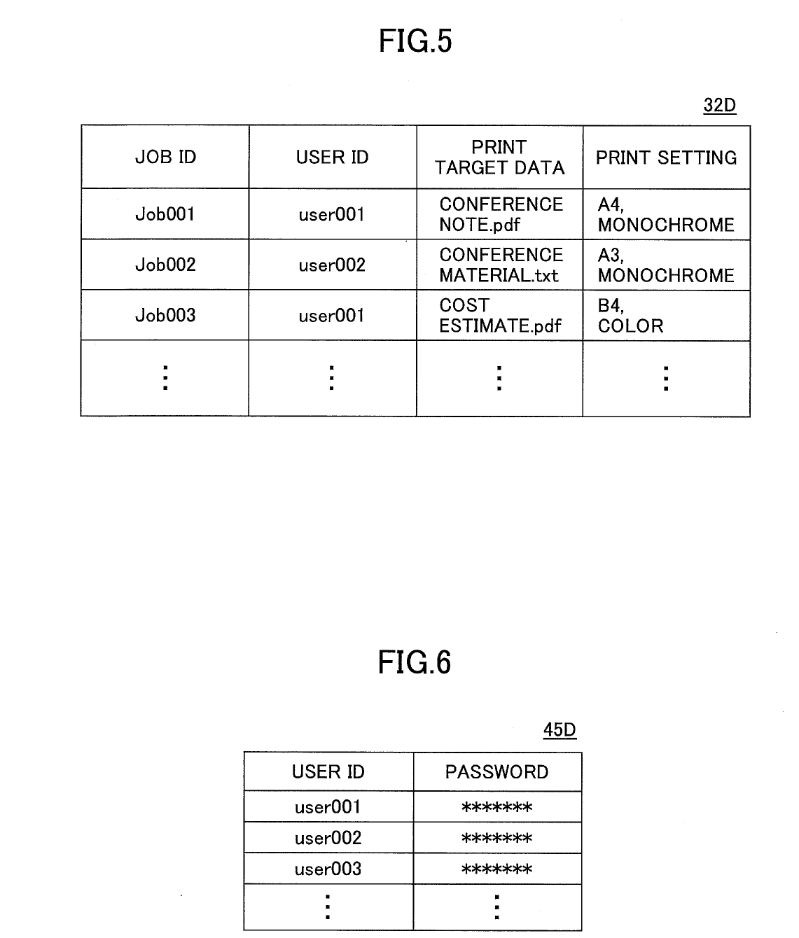

For example, as illustrated in FIG. 6, the authentication information table 45D includes data items of a user ID of the user, a password, etc., used by the user for logging into the image forming apparatus 10. The authentication unit 41 refers to the authentication information table 45D, and performs authentication as to whether a pair of a user ID and password, which is included in an authentication request received from the authentication communication unit 13 of the image forming apparatus 10, is present in the authentication information table 45D.

The user point information storage unit 46 is realized by, for example, the HDD 108 or a storage device, etc., connected via the upper limit management device 40 and a network, and stores a user point information table 46D for managing the remaining point value, etc., of the user.

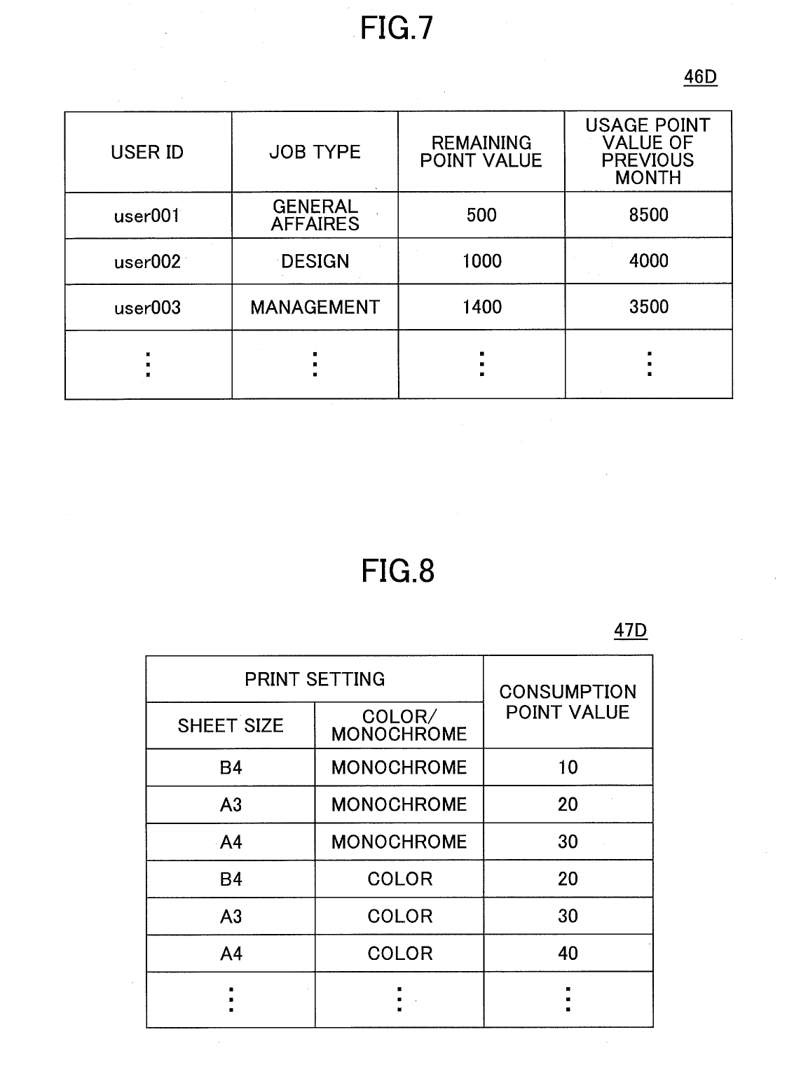

For example, as illustrated in FIG. 7, the user point information table 46D includes data items of a user ID of the user, a job type indicating the type of business of the user, the remaining point value of the user, a usage point value of the previous month indicating the past record of the point value used in a predetermined period in the past (here, one month), etc. Here, the remaining point value in the user point information table 46D is reset to the initial point value, at every predetermined time interval (here, “at every month”). That is, at every predetermined time interval, the point information update unit 44 updates the remaining point value in the user point information table 46D to the initial point value, based on an initial point information table 48D.

The consumption point information storage unit 47 is realized by, for example, the HDD 108 or a storage device, etc., connected via the upper limit management device 40 and a network, and stores a consumption point information table 47D for managing the consumption point value according to a print setting of a print job.

For example, as illustrated in FIG. 8, the consumption point information table 47D includes data items of a print setting indicating the print setting contents of the print job, a consumption point value indicating the point value consumed when the print job having the print setting is executed, etc. This example indicates that when “color” printing is performed by a sheet size “A4”, the consumption point value is “40”.

The initial point information storage unit 48 is realized by, for example, the HDD 108 or a storage device, etc., connected via the upper limit management device 40 and a network, and stores an initial point information table 48D for managing the initial point value of each job type.

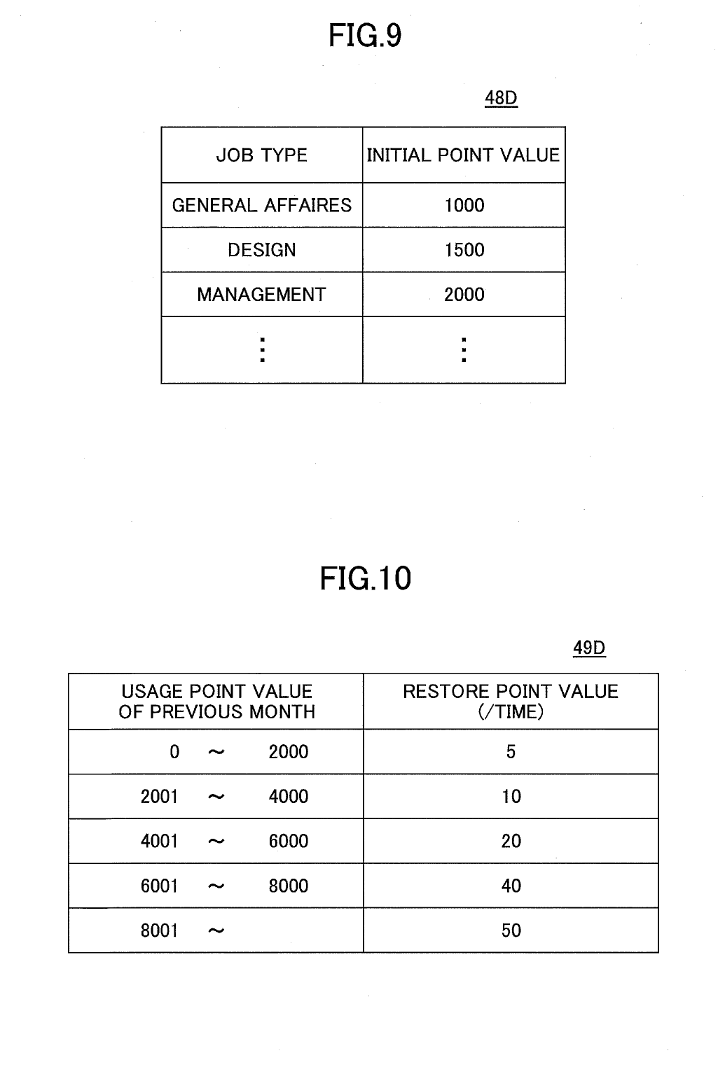

For example, as illustrated in FIG. 9, the initial point information table 48D includes data items of the job type indicating the business type, an initial point value indicating a point value that is set for the user at every predetermined time interval such as the beginning of every month, etc. Accordingly, different initial point values can be set according to the job types of the users. That is, for example, different initial point values can be set for a user having a job type that requires a large amount of printing in business operations, and a user having a job type that requires a small amount of printing in business operations.

The restore point information storage unit 49 is realized by, for example, the HDD 108 or a storage device, etc., connected via the upper limit management device 40 and a network, and stores a restore point information table 49D for managing point values for restoring the remaining point value at every predetermined time interval.

For example, as illustrated in FIG. 10, the restore point information table 49D includes data items of a usage point value of a previous month indicating the past record of the point value used in a past predetermined period (here, “one month”), a restore point value to be restored at every predetermined time interval (here, “every hour”), etc. For example, for a user having a user ID “user 003”, the usage point value of the previous month is “3500”, and therefore the remaining point value of this user is restored by “10” points at every hour. As described above, in the present embodiment, the restoring amount of the remaining point value of the user is varied according to the past usage record of the point value in a past predetermined period. Accordingly, for example, for a user who has performed a large amount of printing in the previous month, a high restore point value is set, because this user is highly likely to perform a large amount of printing in the next month also. On the other hand, for a user who has performed a small amount of printing in the previous month, a low restore point value is set for the next month.

As described above, in the present embodiment, for each user, for example, an initial point value is set (given) as the remaining point value, according to the job type at the beginning of every month. Furthermore, the remaining point value is restored in units of predetermined point values at every hour, up to (without exceeding) the initial point value that is the upper limit value. Accordingly, the user can perform printing according to a plan, in consideration of the point values to be restored. Note that the consumption point value according to the print setting, the initial point value for each job type, the restore point value according to the past usage record, etc., may be set in advance by an administrator user (a user having the authority of an administrator, etc.), of the upper limit management system 1.

### <Process Details>

Next, details of a process by the upper limit management system 1 according to the first embodiment are described.

<<Series of Processes Relevant to Function Usage>>

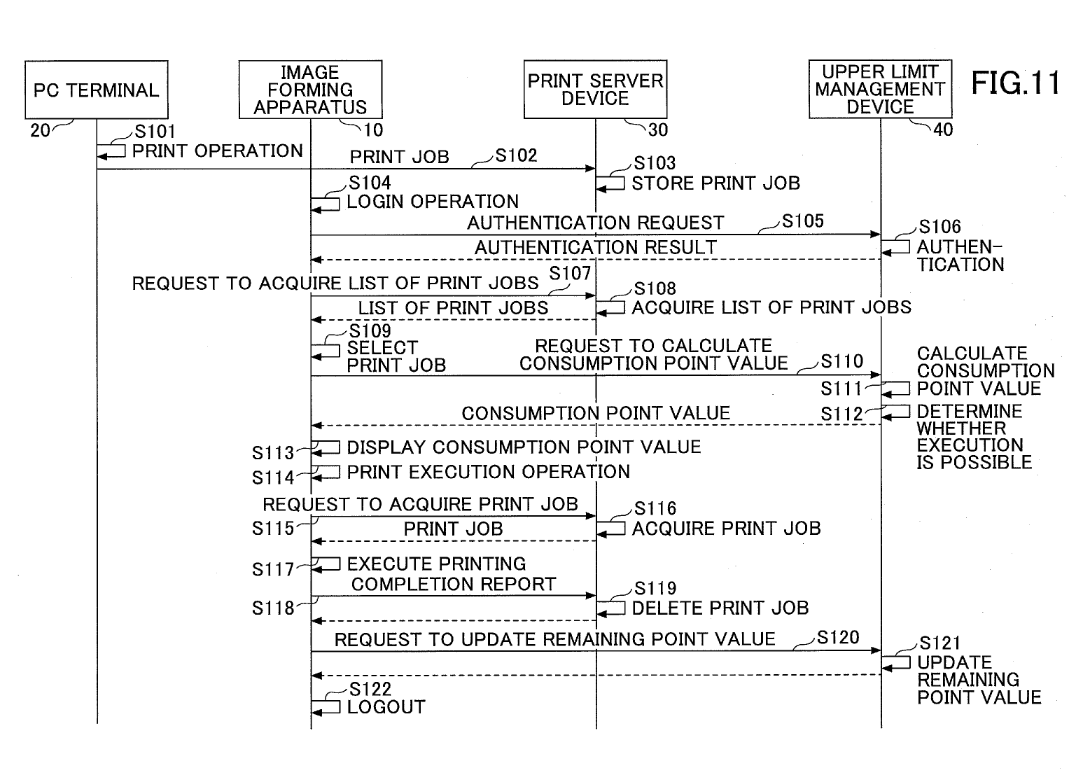

First, a series of processes performed until a print job, which is generated as the user makes a print request at the print application 21 of the PC terminal 20, is executed and printed at the image forming apparatus 10, is described with reference to FIG. 11. FIG. 11 is a sequence diagram of an example of a series of processes relevant to function usage according to the first embodiment.

First, the user operates the PC terminal 20, and performs an operation relevant to a print request at the print application 21 (step S101). Accordingly, a print job is generated by the print application 21. Note that the generated print job includes a job ID, a user ID, print target data, print settings, etc., as described above.

Next, the print application 21 of the PC terminal 20 sends the print job to the print server device 30 (step S102). The print job management unit 31 of the print server device 30 stores the print job received from the PC terminal 20, in the print job table 32D. Accordingly, the print job that is generated by the print application 21 of the PC terminal 20 is stored in the print server device 30.

In order to perform printing by executing the print job, which is stored in the print server device 30, at the image forming apparatus 10, first, the user performs a login request operation to the image forming apparatus 10 (step S104). For example, this may be done by the user inputting a user ID and a password from the operation panel 220 of the image forming apparatus 10, causing the external device I/F 240 to read the external device 240a, such as a non-contact type IC card, etc., in which the user ID, etc., is recorded.

The main body control unit 11 of the image forming apparatus 10 requests the authentication communication unit 13 to perform a process relevant to authentication, when the user performs the login request operation. Then, the authentication communication unit 13 sends an authentication request including the user ID and the password, to the upper limit management device 40, in response to the request (step S105).

The authentication unit 41 of the upper limit management device 40 performs an authentication process, when the authentication request is received from the image forming apparatus 10 (step S106). That is, the authentication unit 41 makes the following two determinations.
Determine whether a pair of a user ID and a password included in the authentication request, is present in the authentication information table 45D.
Refer to the user point information table 46D, and determine whether the remaining point value of the user corresponding to the user ID included in the authentication request, is “0”.

When a pair of a user ID and a password included in the authentication request, is present in the authentication information table 45D, and the remaining point value of the user corresponding to the user ID is not “0”, the authentication unit 41 sends an authentication result indicating authentication successful, to the image forming apparatus 10. Accordingly, the login by the user, who performed the login request operation at the image forming apparatus 10, is completed. On the other hand, in a case other than the above, the authentication unit 41 sends an authentication result indicating authentication unsuccessful, or an authentication result indicating that the remaining point value is “0”, to the image forming apparatus 10.

When the login by the user is completed, the main body control unit 11 of the image forming apparatus 10 requests the print job communication unit 14 to acquire a list of print jobs that can be executed by the user. Then, the print job communication unit 14 sends the request to acquire a list of print jobs to the print server device 30, in response to the request (step S107). Note that the request to acquire a list of print jobs includes the user ID of the user who has logged into the image forming apparatus 10.

When the acquisition request is received, the print job management unit 31 of the print server device 30 acquires the job IDs of print jobs that can be executed by the user ID included in the acquisition request, the file names of the print target data, print settings, etc., from the print job table 32D (step S108). Then, the acquired job IDs, file names of print target data, print settings, etc., are sent to the image forming apparatus 10 as a list of print jobs. Note that a print job that can be executed is, for example, a print job corresponding to the same user ID as the user ID of the user who has logged into the image forming apparatus 10, a print job that the user can execute by substitute printing, etc.

When the list of print jobs is received from the print server device 30, the main body control unit 11 of the image forming apparatus 10 displays the list of print jobs on the operation panel 220. The user selects a print job that the user desires to print, from the list of print jobs displayed on the operation panel 220 of the image forming apparatus 10 (step S109).

When a print job is selected by the user from the list of print jobs, the main body control unit 11 of the image forming apparatus 10 requests the point communication unit 15 to calculate the consumption point value consumed in a case where the selected print job is executed. Then, the point communication unit 15 sends a request to calculate the consumption point value to the upper limit management device 40, in response to the request (step S110). Note that the request to calculate the consumption point value includes the user ID of the user who has logged into the image forming apparatus 10, and the print setting of the print job selected by this user.

When the request to calculate the consumption point value is received, the consumption point calculating unit 42 of the upper limit management device 40 calculates the consumption point value to be consumed in a case where the print job selected by the user is executed (step S111). Specifically, the consumption point calculating unit 42 acquires (calculates) a consumption point value from the consumption point information table 47D, based on the print setting included in the request to calculate the consumption point value. For example, when the print job selected by the user has a print setting to perform “color” printing by a sheet size “A4”, the consumption point value is calculated as “40”. Note that when the print job selected by the user is for printing a plurality of pages, the consumption point calculating unit 42 may obtain the consumption point value by multiplying the consumption point value calculated as described above, by the number of pages.

Next, the consumption point calculating unit 42 of the upper limit management device 40 requests the remaining point determining unit 43 to determine whether the user has a remaining point value by which the print job can be executed. Then, the remaining point determining unit 43 refers to the user point information table 46D, and determines whether the remaining point value of the user is greater than or equal to the consumption point value calculated in step S111 as described above (step S112). Then, if the remaining point determining unit 43 determines that the remaining point value of the user is greater than or equal to the consumption point value, the calculated consumption point value is sent to the image forming apparatus 10 via the consumption point calculating unit 42. On the other hand, if the remaining point determining unit 43 determines that the remaining point value of the user is less than the consumption point value, a report indicating that the print job cannot be executed due to an insufficiency in the remaining point value, is sent to the image forming apparatus 10 via the consumption point calculating unit 42.

When the consumption point value is received from the upper limit management device 40, the main body control unit 11 of the image forming apparatus 10 displays the consumption point value on the operation panel 220 (step S113). Accordingly, the user can confirm the point value to be consumed, in a case where the print job that the user himself has selected is executed.

Note that in step S111 described above, in addition to the consumption point value calculated by the consumption point calculating unit 42, the upper limit management device 40 may send a point value obtained by subtracting the consumption point value from the user's remaining point value, to the image forming apparatus 10. Accordingly, in step S113 described above, the image forming apparatus 10 can display a point value obtained by subtracting the consumption point value from the user's remaining point value, in addition to the consumption point value, on the operation panel 220. Therefore, in this case, the user can confirm both the point value to be consumed in a case where the print job selected by the user himself is executed, and the remaining point value of the user himself after the print job is executed.

Next, the user performs an operation of executing the print job selected by the user himself, via the operation panel 220 of the image forming apparatus 10 (step S114).

When the user performs an operation of executing the print job, the main body control unit 11 of the image forming apparatus 10 requests the print job communication unit 14 to acquire the print job selected by the user. Then, the print job communication unit 14 sends a request to acquire the print job selected by the user, to the print server device 30, in response to the request (step S115). Note that the request to acquire the print job includes the job ID of the print job selected by the user in step S109 described above.

When the request to acquire the print job is received from the image forming apparatus 10, the print job management unit 31 of the print server device 30 acquires a print job corresponding to the job ID included in the acquisition request, from the print job table 32D (step S116). Then, the print job management unit 31 sends the acquired print job to the image forming apparatus 10.

When the print job is received from the print server device 30, the main body control unit 11 of the image forming apparatus 10 requests the main body function unit 12 to execute the print job. Then, the main body function unit 12 executes the print job, and performs printing (step S117). That is, the main body function unit 12 prints the print target data included in the print job received from the print server device 30, by the print settings included in the print job. Accordingly, the execution of the print job selected by the user is completed.

When the execution of the print job is completed, the main body control unit 11 of the image forming apparatus 10 requests the print job communication unit 14 to send a completion report. Then, the print job communication unit 14 sends a completion report of the print job executed in step S117 described above, to the print server device 30 (step S118). Note that the completion report of the print job includes the job ID of the print job executed in step S117 described above.

When the completion report is received, the print job management unit 31 of the print server device 30 deletes the print job corresponding to the job ID included in the completion report, from the print job table 32D (step S119). Then, the print job management unit 31 sends a report indicating that the deletion is completed, to the image forming apparatus 10.

Next, the main body control unit 11 of the image forming apparatus 10 requests the point communication unit 15 to update the user's remaining point value. Then, the point communication unit 15 sends an update request of the user's remaining point value, to the upper limit management device 40 (step S120). Note that the update request of the remaining point value includes the user ID of the user who has logged into the image forming apparatus 10, and the consumption point value received by the image forming apparatus 10 from the upper limit management device 40 in step S112 described above.

When the update request is received, the consumption point calculating unit 42 of the upper limit management device 40 requests the point information update unit 44 to update the user's remaining point value included in the update request. Then, in the user point information table 46D, the point information update unit 44 updates the remaining point value by subtracting the consumption point value included in the update request, from the remaining point value of the user corresponding to the user ID included in the update request (step S121). As described above, the remaining point value of the user who executed the print job is consumed according to the print settings of the print job.

When the printing is completed in the image forming apparatus 10, the user performs a logout request operation to the image forming apparatus 10 (step S112). On the other hand, when the user desires to perform further printing (when a logout request operation is not performed), the process of step S107 described above is executed.

By the above processes, the series of processes performed until the print job, which is generated as the user makes a print request at the print application 21 of the PC terminal 20, is executed and printed out at the image forming apparatus 10, is completed. As described by the series of processes, the user is able to execute a print job and perform printing, within the range of the remaining point value of the user himself.

<<Point Restoring Process>>

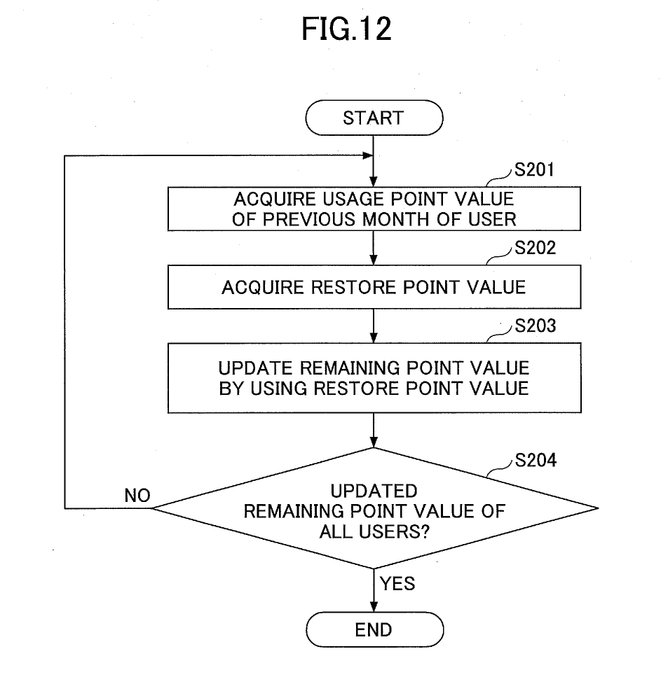

Next, a process of restoring the remaining point value of the user at every predetermined time interval (at every hour in the present embodiment) performed in the upper limit management device 40, is described. Here, in the present embodiment, the predetermined time interval is one hour; however, the present embodiment is not so limited. The predetermined time interval may be, for example, a certain time interval within a range of several minutes through several hours. The predetermined time interval is set for the purpose of restoring the remaining point value of the user for a plurality of times within the business hours of the user, such that the user performs printing according to a plan in consideration of the point value to be restored for the user. FIG. 12 is a flowchart of an example of a point restoring process according to the first embodiment. The point restoring process of FIG. 12 (that is, the processes of steps S201 through S204 described below), is executed at every predetermined time interval (at every hour in the present embodiment). Furthermore, the point restoring process of FIG. 12 may be executed at every predetermined time interval, for example, within the business hours of the user.

First, the point information update unit 44 of the upper limit management device 40 acquires the usage point value of the previous month of one user, from the user point information table 46D (step S201).

Next, the point information update unit 44 of the upper limit management device 40 acquires a restore point value from the restore point information table 49D, based on the usage point value of the previous month acquired in step S201 (step S202). For example, when the point information update unit 44 acquires “8500” as the usage point value of the previous month of the user having a user ID “user001” in step S201, the point information update unit 44 acquires a restore point value “50” from the restore point information table 49D.

Next, the point information update unit 44 of the upper limit management device 40 updates the remaining point value of the one user in the user point information table 46D, by adding the restore point value acquired in step S202 to the remaining point value of the user (step S203). For example, the point information update unit 44 adds the restore point value “50” acquired in step S202, to the remaining point value “500” of the user ID “user001”, to update the remaining point value of the user to “550”. Note that at this time, the point information update unit 44 updates the remaining point value of the user up to (without exceeding) an initial point value that is the upper limit value determined according to the job type of the user.

For example, in a case where the difference between the initial point value and the remaining point value of the user is 20 points, and the restore point value set for the user is 30 points, the restore point value to be restored with respect to the remaining point value of the user becomes 20 points, such that the remaining point value after restoring points does not exceed the initial point value.

Finally, the point information update unit 44 of the upper limit management device 40 determines whether the remaining point values of all of the users in the user point information table 46D have been updated (step S204). If the remaining point values of all of the users have been updated, the process is ended. On the other hand, if there is a user for which the remaining point value has not been updated, the process returns to step S201.

As described above, in the upper limit management device 40 according to the present embodiment, the remaining point value of the user is updated at every predetermined time interval. At this time, the upper limit management device 40 regains the point value according to the past record of the point value used (consumed) by the user in a predetermined period in the past. Accordingly, the user can perform printing according to a plan in consideration of the point value to be restored for the user. Therefore, it is possible to prevent the point value, which is given to the user in advance (initial point value), from becoming excessively high, and TCO can be reduced.

### Second Embodiment

Next, the upper limit management system 1 according to a second embodiment is described. The upper limit management system 1 according to the second embodiment is different from that of the first embodiment, in that the consumption point value is classified according to the time period in which the user executes the print job and the job type of the user, and the remaining point value is restored according to the job type of the user. Note that in the second embodiment, the functions and processes that are substantially the same as those of the first embodiment are denoted by the same reference numerals, and descriptions are omitted according to need.

### <Functional Configuration>

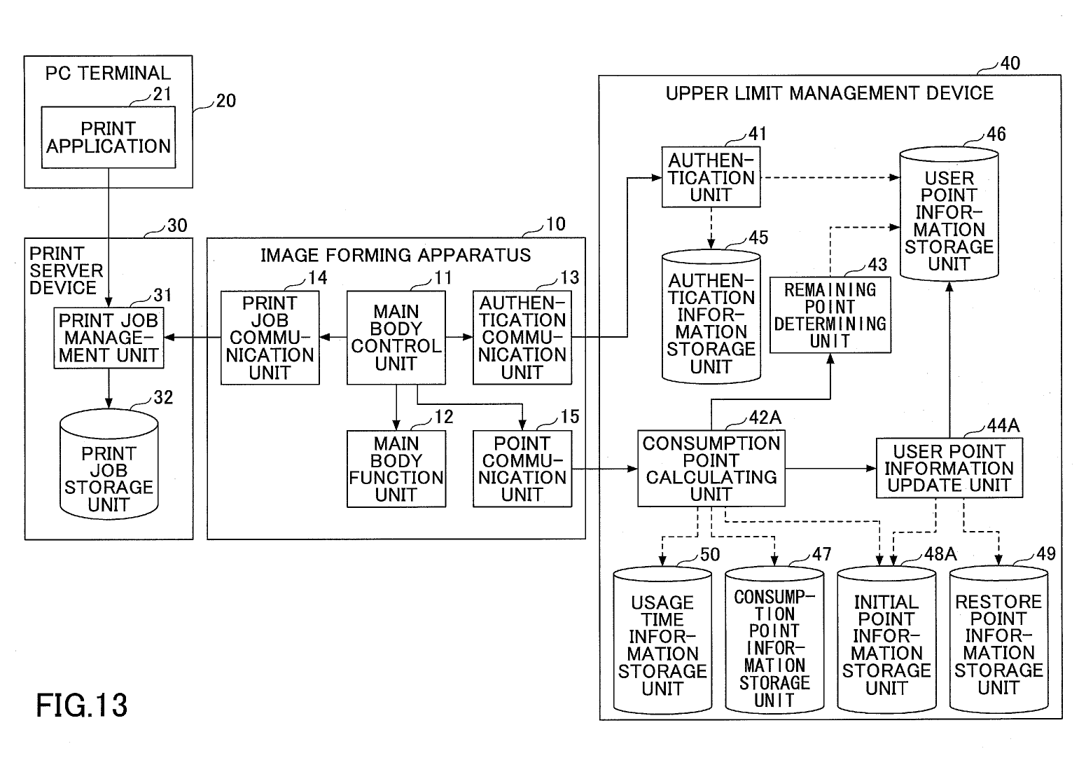

First, the functional configuration of the upper limit management system 1 according to the second embodiment is described. The upper limit management system 1 according to the second embodiment is realized by, for example, the functional blocks as illustrated in FIG. 13. FIG. 13 is a functional block diagram of an example of the upper limit management system 1 according to the second embodiment.

<<Upper Limit Management Device>>

In the upper limit management device 40 according to the second embodiment, functions of a consumption point calculating unit 42A and a point information update unit 44A are different from those of the first embodiment. Furthermore, the upper limit management device 40 according to the second embodiment is different from that of the first embodiment in that an initial point information storage unit 48A and a usage time information storage unit 50 are used.

The consumption point calculating unit 42A calculates a consumption point value in response to a request from the point communication unit 15 of the image forming apparatus 10, by referring to the consumption point information storage unit 47, the usage time information storage unit 50, and the initial point information storage unit 48A.

The point information update unit 44A restores the remaining point value of the user at every predetermined time interval (at every one hour in the present embodiment), by referring to the initial point information storage unit 48A and the restore point information storage unit 49.

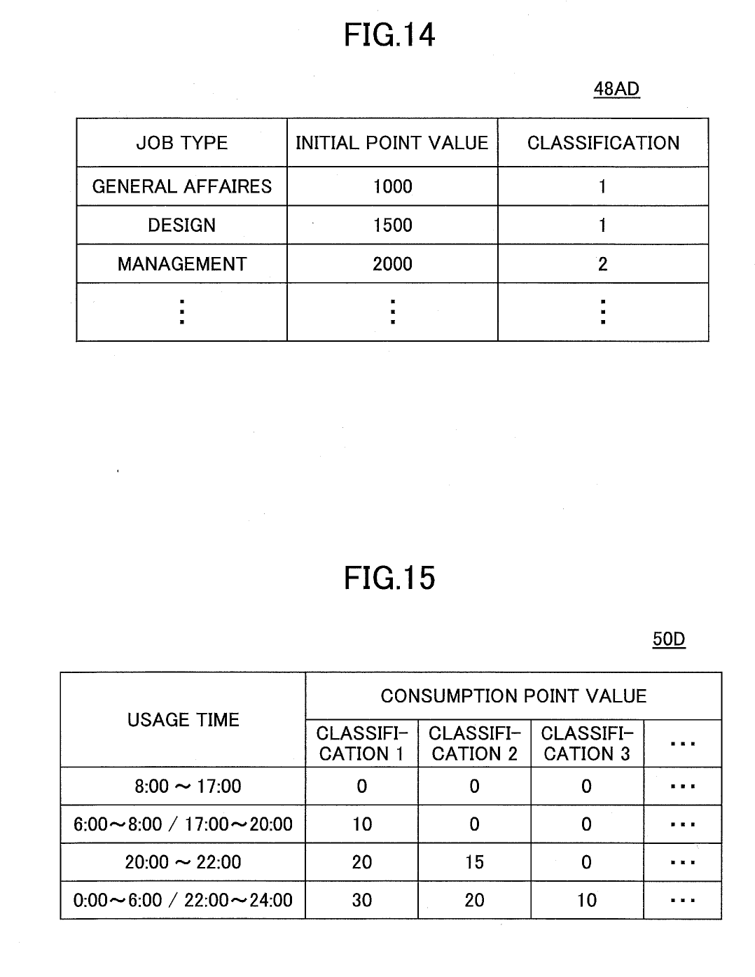

The initial point information storage unit 48A stores an initial point information table 48AD. For example, as illustrated in FIG. 14, the initial point information table 48AD includes a data item of classification of the job type, in addition to the data items of the first embodiment. Classification is for classifying job types having similar usage forms of using the image forming apparatus 10. For example, a job type “general affairs” and a job type “design” belong to the same classification “1”. As described below in detail, the consumption point value and the restore point value are determined according to the classification.

The usage time information storage unit 50 is realized by, for example, the HDD 108 or a storage device, etc., connected via the upper limit management device 40 and a network, and stores a usage time information table 50D for managing the consumption point value according to the usage time and the classification of the job type.

For example, as illustrated in FIG. 15, the usage time information table 50D includes the data items of the usage time of using the image forming apparatus 10, the consumption point value according to the classification of the job type, etc. This example indicates that when a user having the job type of classification 1 (for example, “general affairs”) executes a print job at the image forming apparatus 10 between 6:00 and 8:00, the consumption point value is “10”.

### <Process Details>

Next, details of a process by the upper limit management system 1 according to the second embodiment are described.

<<Series of Processes Relevant to Function Usage>>

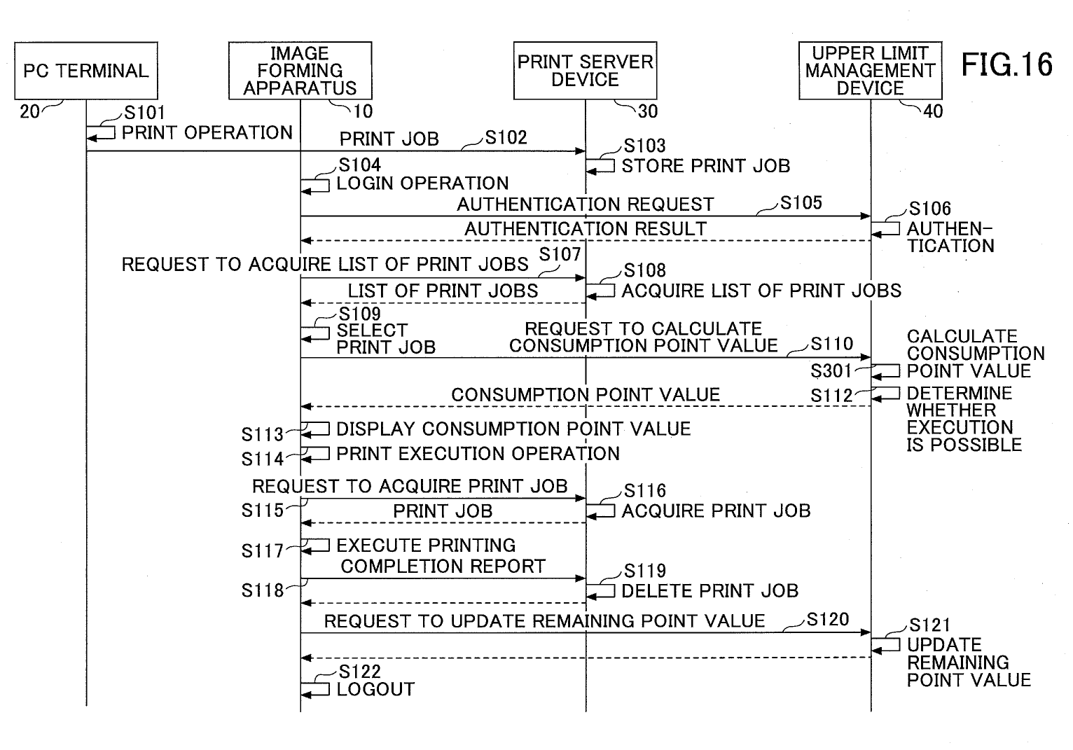

First, a series of processes performed until a print job, which is generated as the user makes a print request at the print application 21 of the PC terminal 20, is executed and printed at the image forming apparatus 10, is described with reference to FIG. 16. FIG. 16 is a sequence diagram of an example of a series of processes relevant to function usage according to the second embodiment. Note that in the series of processes relevant to function usage according to the second embodiment, the process of step S301 is different from the first embodiment. Therefore, in the following, the process of step S301 is described.

When a request to calculate the consumption point value is received, the consumption point calculating unit 42A of the upper limit management device 40 calculates the consumption point value to be consumed in a case where the print job selected by the user is executed (step S301). Specifically, the consumption point calculating unit 42A calculates the consumption point value as follows.

(1) Acquire the consumption point value (referred to as “first consumption point value”) from the consumption point information table 47D, based on the print setting included in the request to calculate the consumption point value.
(2) Acquire the consumption point value (referred to as “second consumption point value”) from the usage time information table 50D, based on the time of receiving the request to calculate the consumption point value and the classification of the job type of the user who selected the print job. Note that the classification of the job type of the user may be acquired from the initial point information table 48AD, after acquiring the job type from the user point information table 46D based on the user ID included in the request to calculate the consumption point value.
(3) Add the first consumption point value and the second consumption point value acquired above, and the addition result is the calculated consumption point value.

As described above, in the upper limit management system 1 according to the present embodiment, the consumption point value is calculated according to the time period in which the user executes the print job and the classification of the job type of the user. Therefore, the administrator user of the upper limit management system 1 can make flexible settings, such as setting a high consumption point value for time periods outside business hours, setting different consumption point values for the respective time periods according to job types, etc. Accordingly, in a case where usage of the image forming apparatus 10 is concentrated and overcrowded in a particular time period, by adjusting the consumption point values of the respective classifications of job types in the particular time period, the overcrowded situation can be mitigated.

<<Point Restoring Process>>

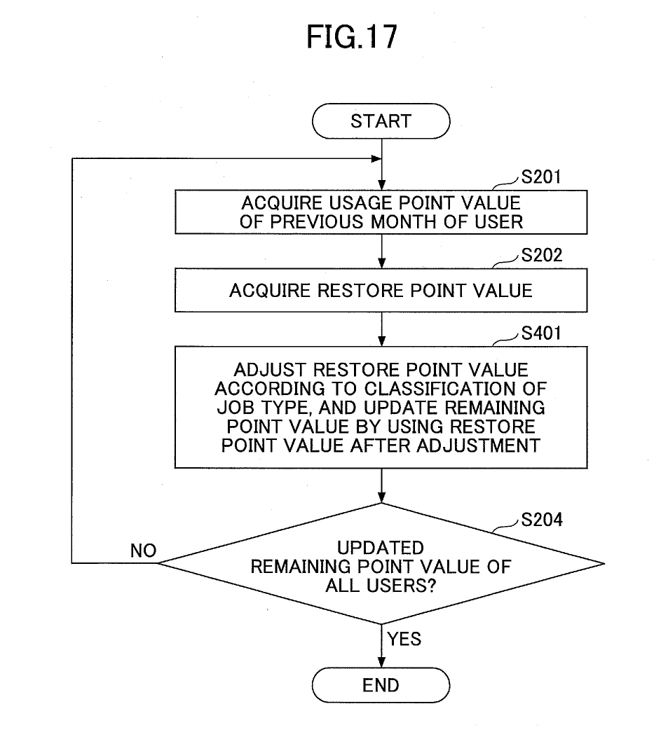

Next, a process of restoring the remaining point value of the user at every predetermined time interval (at every hour in the present embodiment) performed in the upper limit management device 40, is described. FIG. 17 is a flowchart of an example of a point restoring process according to the second embodiment. Note that in the point restoring process according to the second embodiment, the process of step S401 is different from the first embodiment. Therefore, in the following, the process of step S401 is described.

The point information update unit 44A of the upper limit management device 40 updates the remaining point value of the one user in the user point information table 46D (step S203).

Specifically, the point information update unit 44A updates the remaining point value of the one user as follows.
(1) Multiply the restore point value acquired in step S202 by the value of the classification of the job type of the one user, to adjust the restore point value. For example, when the classification of the job type of the one user is “2”, the restore point value acquired in step S202 is multiplied by two. Note that here, the restore point value is adjusted by being multiplied by the value of the
classification of the job type; however, the present embodiment is not so limited, the restore point value may be adjusted by being multiplied by a
predetermined value according to the classification of the job type.
(2) The remaining point value of the one user in the user point information table 46D is updated by adding the restore point value that has been adjusted. Note that at this time, the point information update unit 44A updates the remaining point value of the user up to (without exceeding) an initial point value that is the upper limit value that is determined according to the job type of the user.

As described above, in the upper limit management device 40 according to the present embodiment, the remaining point value of the user is updated at every predetermined time interval. At this time, the upper limit management device 40 adjusts the restore point value according to the classification of the job type of the user. Therefore, the administrator user of the upper limit management system 1 can make flexible settings, such as setting a high restore point value for a user having a job type belonging to a particular classification, while setting a low restore point value for a user having a job type belonging to another particular classification.

### Third Embodiment

Next, the upper limit management system 1 according to a third embodiment is described. The upper limit management system 1 according to the third embodiment is different from that of the first embodiment, in that the remaining point value corresponds to a number of times that the user can log into the image forming apparatus 10 and give an instruction to execute printing in the image forming apparatus 10. Note that in the third embodiment, the functions and processes that are substantially the same as those of the first embodiment are denoted by the same reference numerals, and descriptions are omitted according to need.

### <Functional Configuration>

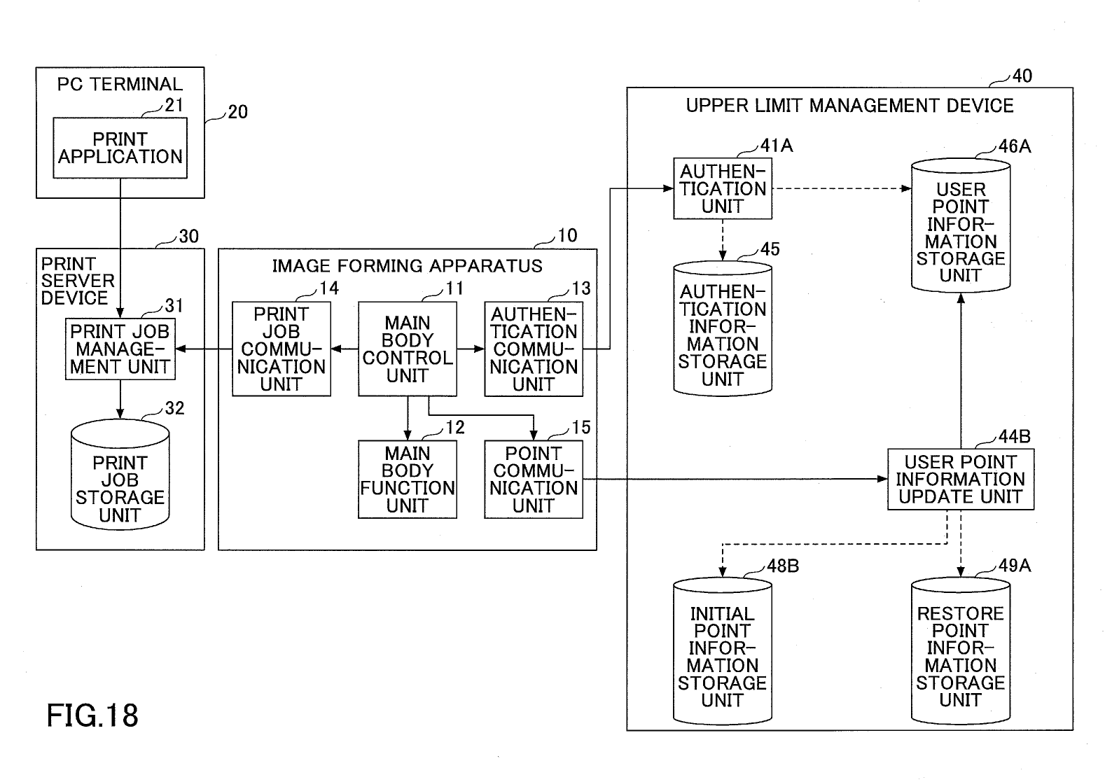

First, the functional configuration of the upper limit management system 1 according to the third embodiment is described. The upper limit management system 1 according to the third embodiment is realized by, for example, the functional blocks as illustrated in FIG. 18. FIG. 18 is a functional block diagram of an example of the upper limit management system 1 according to the third embodiment.

<<Upper Limit Management Device>>

The upper limit management device 40 according to the third embodiment is different from that of the first embodiment in that the consumption point calculating unit 42 and the remaining point determining unit 43 are not included, and an authentication unit 41A and a point information update unit 44B have different functions from those of the first embodiment. Furthermore, the upper limit management device 40 according to the third embodiment is different from that of the first embodiment in that the consumption point information storage unit 47 is not used, but a user point information storage unit 46A, an initial point information unit 48B, and a restore point information unit 49A are used.

When the remaining point value of the user relevant to the authentication request is determined not to be “0”, the authentication unit 41A sends a result obtained by performing a predetermined calculation on the remaining point value, together with the authentication result, to the image forming apparatus 10.

The point information update unit 44B updates the remaining point value of the user, in response to a request from the image forming apparatus 10. Furthermore, the point information update unit 44B restores the remaining point value of the user at every predetermined time interval (at every hour in the present embodiment), by referring to the restore point information unit 49A.

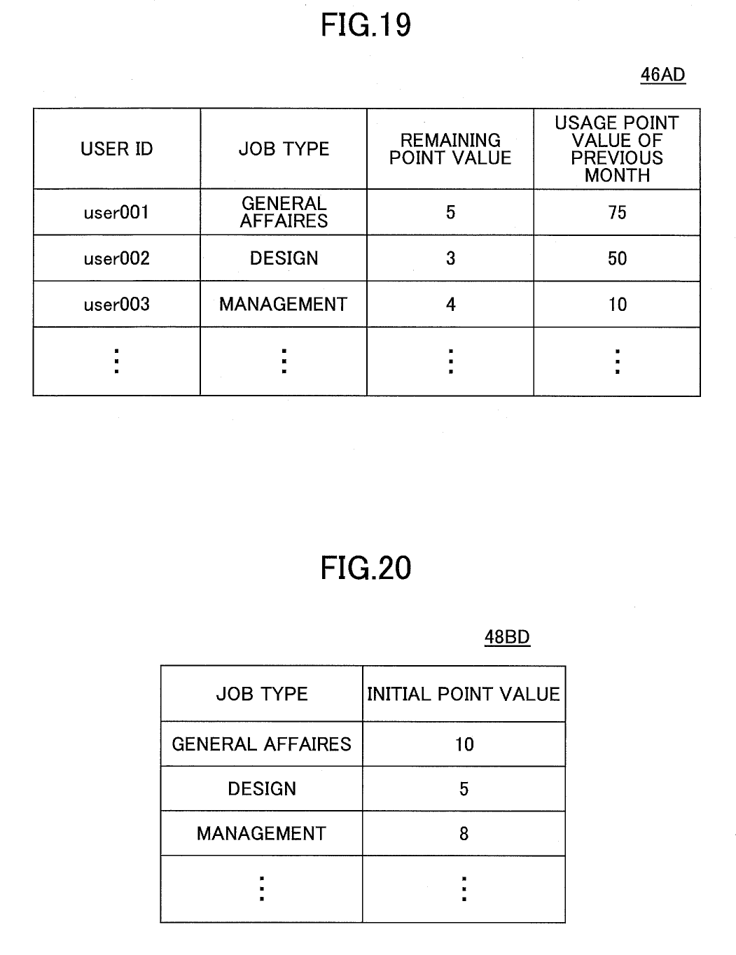

The user point information storage unit 46A stores a user point information table 46AD. As illustrated in FIG. 19, the user point information table 46AD includes data items of user ID, job type, the remaining point value, and the usage point value of the previous month indicating the past record of the point value used in a past predetermined period (here, “one month”). Here, in the present embodiment, the remaining point value corresponds to the number of times the user can log into the image forming apparatus 10. The number of times the user can log in is, more specifically, the number of times the user can perform an act, where one act includes logging into the image forming apparatus 10, executing printing of at least one print job, and logging out.

For example, it is indicated that the user having the user ID “user001” can log into the image forming apparatus 10 five more times, at the present time point. Furthermore, the usage point value of the previous month is the number of times that the user has logged into the image forming apparatus 10 in the previous month. As described above, by setting the remaining point value to be the number of times that the user can log into the image forming apparatus 10, it is possible for the user to consider an efficient way of using the image forming apparatus 10. For example, when the user needs to perform a plurality of printing operations in one day, the user can perform the plurality of printing operations by logging into the image forming apparatus 10 once.

The initial point information unit 48B stores an initial point information table 48BD. For example, as illustrated in FIG. 20, the initial point information table 48BD includes data items of the job type, the initial point value indicating the point value that is set for the user at every predetermined time interval such as the beginning of every month, etc. Here, for example, an initial point value is the number of times that the user can log into the image forming apparatus 10, which is set for the user according to the job type at the beginning of every month, etc.

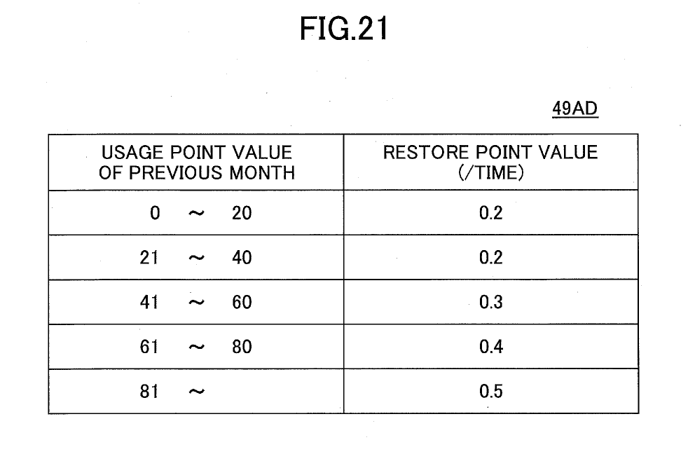

Similar to the above, the restore point information unit 49A stores a restore point information table 49AD. For example, as illustrated in FIG. 21, the restore point information table 49AD includes data items of the usage point value of the previous month indicating the past record of the point value used in a predetermined period in the past (here, “one month”), the restore point value to be restored at every predetermined time interval (here, “one hour”), etc. For example, for the user of the user ID “user001” whose usage point value of the previous month is “75”, the remaining point value is restored by “0.4” at every hour. Therefore, for the user of the user ID “user001”, for example, the remaining point value is restored by “3.2” in 8 hours that is the business hours of one day.

### <Process Details>

Next, details of a process by the upper limit management system 1 according to the third embodiment are described. The point restoring process by the upper limit management system 1 according to the third embodiment is the same as that of the first embodiment, and therefore a description thereof is omitted.

<<Series of Processes Relevant to Function Usage>>

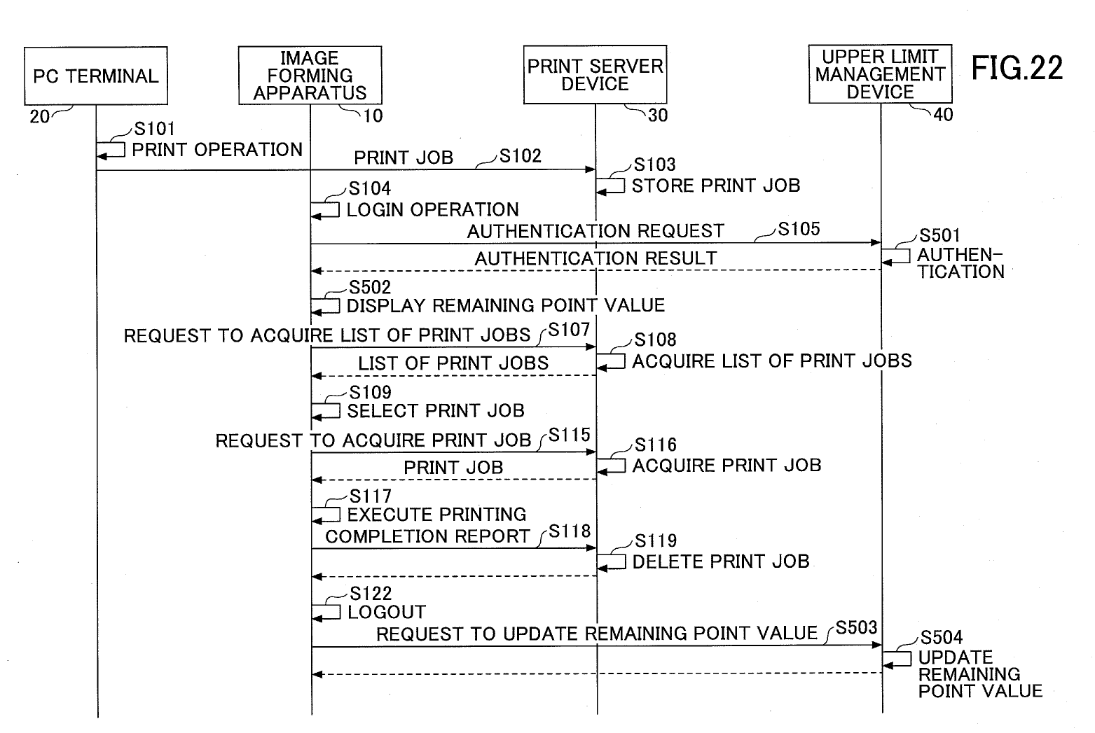

A series of processes performed until a print job, which is generated as the user makes a print request at the print application 21 of the PC terminal 20, is executed and printed at the image forming apparatus 10, is described with reference to FIG. 22. FIG. 22 is a sequence diagram of an example of a series of processes relevant to function usage according to the third embodiment. Note that in the series of processes relevant to function usage according to the third embodiment, the processes of steps S501 through S504 are different from the first embodiment. Therefore, in the following, the processes of steps S501 through S504 are described.

When an authentication request is received from the image forming apparatus 10, the authentication unit 41A of the upper limit management device 40 performs an authentication process (step S501). That is, the authentication unit 41A makes the following two determinations.
Determine whether a pair of a user ID and a password included in the authentication request, is present in the authentication information table 45D.
Refer to the user point information table 46AD, and determine whether the remaining point value of the user corresponding to the user ID included in the authentication request, is less than “1”.

When a pair of a user ID and a password included in the authentication request is present in the authentication information table 45D, and the remaining point value of the user corresponding to the user ID is not less than “1”, the authentication unit 41 sends an authentication result including a value obtained by subtracting one from the remaining point value, to the image forming apparatus 10. Accordingly, the login by the user, who performed the login request operation at the image forming apparatus 10, is completed. On the other hand, in a case other than the above, the authentication unit 41 sends an authentication result indicating authentication unsuccessful, or an authentication result indicating that the remaining point value is less than “1” (not a remaining point value by which login can be performed once for printing), to the image forming apparatus 10.

The main body control unit 11 of the image forming apparatus 10 displays the value obtained by subtracting one from the remaining point value sent from the upper limit management device 40, on the operation panel 220 (step S502). Accordingly, the user can be aware of the remaining point value of himself (the number of times that the user himself can log into the image forming apparatus 10 after the current login has ended). Note that when a value less than the decimal point is included in the remaining point value displayed on the operation panel 220, the value less than the decimal point may be displayed, or the value less than the decimal point may be rounded down.

When a user makes a logout request operation, the main body control unit 11 of the image forming apparatus 10 requests the point communication unit 15 to update the remaining point value of the user. Then, the point communication unit 15 sends a request to update the remaining point value of the user, to the upper limit management device 40 (step S1503). On the other hand, when the user desires to perform further printing (when a logout request operation is not performed), the process of step S107 described above is executed. Therefore, while the user is logging in the image forming apparatus 10, the user can execute a desired print job (the processes of steps S107 through S119 can be repeatedly executed).

That is, in the present embodiment, the user can log into the image forming apparatus 10 up to (without exceeding) a number of times corresponding to the remaining point value that is the upper limit number of times, and after the user logs in, the point value is not consumed by executing print jobs. Therefore, when a logout request operation is performed without executing printing after the user has logged in, the main body control unit 11 does not request to the point communication unit 15 to update the remaining point value, and the point communication unit 15 does not send an update request to the upper limit management device 40 (the image forming apparatus 10 only reports the logout).

When a request to update the remaining point value is received, the point information update unit 44A of the upper limit management device 40 updates the remaining point value in the user point information table 46AD by subtracting one from the remaining point value of the user of the user ID included in the update request (step S504). As described above, the remaining point value of the user is consumed according to the number of times of logging into the image forming apparatus 10.

As described above, in the upper limit management system 1 according to the present embodiment, the remaining point value is consumed according to the number of times that the user logs into the image forming apparatus 10. Therefore, in upper limit management system 1 according to the present embodiment, the user can efficiently use the image forming apparatus 10 (for example, collectively executing a plurality of print jobs while logging in once).

Note that in the third embodiment, the number of points to be consumed is one, no matter how many times the user executes printing from when the user logs into the image forming apparatus 10 once, to when the user, who has logged in, logs out. This is not much effective in a usage mode where, for example, the user can basically instruct to execute printing from the PC terminal 20 to the image forming apparatus 10, and the user can execute printing without logging into the image forming apparatus 10.

Meanwhile, in a usage mode where the user needs to log into the image forming apparatus 10 in order to use the image forming apparatus 10 for printing, the system enables the user to use the image forming apparatus 10 efficiently, as described above.

In this regard, a single consumption unit may mean that the user has instructed print execution only once and printing has been executed only once (one point is consumed if one point corresponds to one execution consumed), instead of a single consumption unit meaning that printing is performed one or more times from when the user logs in once to when the user logs out (one point is consumed if one point corresponds to logging in once). That is, as described in step S109 and onward in FIG. 22, in a user mode where the user selects a print job from a list of print jobs, instructs to execute printing, and printing of the selected print job is executed, the user can select a plurality of print jobs until the user instructs the execution.

Therefore, the consumed points are unaffected regardless of the number of print jobs selected from the list of print jobs, but the number of times of instructing to execute printing may be proportionate to the consumed points.

In this case, when printing is executed in step S117, the image forming apparatus 10 is to update the remaining point value received from the upper limit management device 40 in step S501 by subtracting one, display the list screen of the print jobs again, and wait for a user's operation (an operation of instructing the print execution or an instruction to request logout).

When printing is executed again, the remaining point value which has been updated by subtracting one, is updated again by subtracting one again. When an operation to request logout is performed, the process proceeds from step S122 to step S503, the remaining point value updated in the image forming apparatus 10 is sent to the upper limit management device 40, and the remaining point value in the user point information table 46AD is updated by the updated remaining point value. At this time, the upper limit management device 40 does not perform the process of subtracting one.

Note that when the updated remaining point value becomes less than “1” as a result of updating the remaining point value in the image forming apparatus 10, it may be possible to reject receiving an instruction operation for print execution from the user, or display an error when such an instruction operation is received, or the user may be forced to log out at the time point when the updated remaining point value becomes less than “1”.

### <Overview>

As described above, in the upper limit management system 1 according to the first embodiment, the user can perform printing by executing print jobs up to (without exceeding) the remaining point value of himself that is the upper limit value. Furthermore, such a remaining point value is updated (that is, initialized) to the initial point value, at every predetermined time interval. Furthermore, in the upper limit management system 1 according to the first embodiment, the user's remaining point value is restored at every predetermined time interval. Accordingly, the user can perform printing according to a plan, in consideration of the point values to be restored. Therefore, it is possible to prevent the point value, which is given to the user in advance (initial point value), from becoming excessively high, and TCO can be reduced.

Furthermore, in the upper limit management system 1 according to the second embodiment, the consumption point value, which is consumed when a print job is executed, is calculated according to the job type of the use who executes the print job and the time period in which the user executes the print job. Furthermore, in the upper limit management system 1 according to the second embodiment, the restore point value for restoring the remaining point value of the user is determined according to the job type of the user. Accordingly, the administrator user of the upper limit management system 1 can flexibly set the consumption point value and the restore point value.

Furthermore, in the upper limit management system 1 according to the third embodiment, the user can log into the image forming apparatus 10 and perform printing, up to (without exceeding) the remaining point value of himself that is the upper limit number of times. Accordingly, the user can efficiently use the image forming apparatus 10 (for example, collectively executing a plurality of print jobs while logging in once). Meanwhile, in the upper limit management system 1 according to the third embodiment, when the user logged into the image forming apparatus 10 but did not perform printing, the remaining point value may not be updated. As described above, in the upper limit management system 1 according to the third embodiment, the remaining point value may be updated when the user has logged into the image forming apparatus 10 and also performed printing.

According to one embodiment of the present invention, an information processing apparatus, a printing system, and an information processing method are provided, which are capable of supporting the efficient usage of a printing function.

Note that the point information update unit 44 for setting the initial point value at every predetermined time interval is an example of a setting unit. The user point information storage unit 46 for managing the remaining point value, etc., of the user is an example of a first storage unit. The restore point information storage unit 49 for managing the restore point value for restoring the remaining point value at every predetermined time interval is an example of a second storage unit. The point information update unit 44 for restoring the remaining point value of the user is an example of a present value increasing unit.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.)

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus. The information processing apparatus, the printing system, and the information processing method are not limited to the specific embodiments described herein, and variations and modifications may be made without departing from the spirit and scope of the present invention.

The present application is based on and claims the benefit of priority of Japanese Priority Patent Application No. 2015-055125, filed on Mar. 18, 2015, the entire contents of which are hereby incorporated herein by reference.

What is claimed is:

1. An information processing apparatus for managing a usage amount of a function relating to image processing, the information processing apparatus comprising:
a setting unit configured to set an upper limit value indicating an upper limit usage amount with respect to the function to be used within a predetermined period;
a first storage unit configured to store a present value indicating a remaining usage amount obtained by subtracting the usage amount of using the function from the upper limit usage amount, when the function is used from when the upper limit value is set to when the predetermined period passes; and
a present value increasing unit configured to increase the present value by an increase value indicating a predetermined usage amount, at a predetermined timing within the predetermined period.

2. The information processing apparatus according to claim 1, further comprising:
a second storage unit configured to store the increase value according to a past usage record value indicating a past usage record amount of using the function by a user in the predetermined period in the past, wherein
the first storage unit stores the present value and the past usage record value for each user, and
the present value increasing unit increases the present value of the user by the increase value according to the past usage record value of the user.

3. The information processing apparatus according to claim 2, wherein
the setting unit sets the upper limit value for each user, and
the present value increasing unit increases the present value of the user, at every predetermined time interval set in advance, based on the present value and the increase value according to the past usage record value of the user, without exceeding the upper limit value of the user.

4. The information processing apparatus according to claim 1, wherein
the first storage unit stores, for each user, a job type of the user, the present value indicating the remaining usage amount by which the user can use the function, and a past usage record value indicating a past usage record amount of using the function by the user in the predetermined period in the past, and
the present value increasing unit increases the present value of the user based on the present value, the job type of the user, and the increase value according to the past usage record value of the user.

5. The information processing apparatus according to claim 4, wherein
the present value increasing unit increases the present value of the user, by adding a value obtained by multiplying the increase value by a predetermined value determined according to the job type of the user.

6. The information processing apparatus according to claim 2, wherein
the first storage unit stores, for each user, the present value and the past usage record value, the present value being obtained by subtracting the usage amount corresponding to a number of times of logging in by the user, from the upper limit usage amount, when the user has logged into the information processing apparatus and used the function, and
the present value increasing unit increases the present value of the user based on the present value and the increase value according to the past usage record value of the user.

7. A printing system for providing a printing function, the printing system being connected via a network to a client terminal in which a user inputs a print job, the printing system comprising:
a setting unit configured to set an upper limit value indicating an upper limit usage amount with respect to the printing function to be used within a predetermined period;
a first storage unit configured to store a present value indicating a remaining usage amount obtained by subtracting a usage amount of using the printing function from the upper limit usage amount, when the printing function is used from when the upper limit value is set to when the predetermined period passes; and
a present value increasing unit configured to increase the present value by an increase value indicating a predetermined usage amount, at a predetermined timing within the predetermined period.

8. The printing system according to claim 7, further comprising:
a second storage unit configured to store the increase value according to a past usage record value indicating a past usage record amount of using the printing function by the user in the predetermined period in the past, wherein
the first storage unit stores the present value and the past usage record value for each user, and
the present value increasing unit increases the present value of the user by the increase value according to the past usage record value of the user.

9. The printing system according to claim 8, wherein
the setting unit sets the upper limit value for each user, and
the present value increasing unit increases the present value of the user, at every predetermined time interval set in advance, based on the present value and the increase value according to the past usage record value of the user, without exceeding the upper limit value of the user.

10. The printing system according to claim 7, wherein
the first storage unit stores, for each user, a job type of the user, the present value indicating the remaining usage amount by which the user can use the printing function, and a past usage record value indicating a past usage record amount of using the printing function by the user in the predetermined period in the past, and
the present value increasing unit increases the present value of the user based on the present value, the job type of the user, and the increase value according to the past usage record value of the user.

11. The printing system according to claim 10, wherein
the present value increasing unit increases the present value of the user, by adding a value obtained by multiplying the increase value by a predetermined value determined according to the job type of the user.

12. The printing system according to claim 8, wherein
the first storage unit stores, for each user, the present value and the past usage record value, the present value being obtained by subtracting the usage amount corresponding to a number of times of logging in by the user, from the upper limit usage amount, when the user has logged into an information processing apparatus that executes the printing function and used the printing function, and
the present value increasing unit increases the present value of the user based on the present value and the increase value according to the past usage record value of the user.

13. An information processing method used in a printing system for providing a printing function, the printing system being connected via a network to a client terminal in which a user inputs a print job, the printing system including
a first storage unit configured to store a present value indicating a remaining usage amount obtained by subtracting a usage amount of using the printing function from an upper limit usage amount, when the printing function is used from when an upper limit value is set to when a predetermined period passes, the upper limit value indicating the upper limit usage amount with respect to the printing function to be used within the predetermined period, the information processing method comprising:
setting the upper limit value; and
increasing the present value by an increase value indicating a predetermined usage amount, at a predetermined timing within the predetermined period.

14. The information processing method according to claim 13, further comprising:
storing, in a second storage unit, the increase value according to a past usage record value indicating a past usage record amount of using the printing function by the user in the predetermined period in the past, wherein
the increasing includes increasing the present value of the user by the increase value according to the past usage record value of the user, wherein the first storage unit stores, for each user, the present value and the past usage record value.

15. The information processing method according to claim 14, wherein
the setting includes setting the upper limit value for each user, and
the increasing includes increasing the present value of the user, at every predetermined time interval set in advance, based on the present value and the increase value according to the past usage record value of the user, without exceeding the upper limit value of the user.

16. The information processing method according to claim 13, wherein
the increasing includes increasing the present value of the user based on the present value, a job type of the user, and the increase value according to a past usage record value of the user, wherein the first storage unit stores, for each user, the job type of the user, the present value indicating the remaining usage amount by which the user can use the printing function, and the past usage record value indicating a past usage record amount of using the printing function by the user in the predetermined period in the past.

17. The information processing method according to claim 16, wherein
the increasing includes increasing the present value of the user, by adding a value obtained by multiplying the increase value by a predetermined value determined according to the job type of the user.

18. The information processing method according to claim 14, wherein
the increasing includes increasing the present value of the user based on the present value and the increase value according to the past usage record value of the user, wherein the first storage unit stores, for each user, the present value and the past usage record value, the present value being obtained by subtracting the usage amount corresponding to a number of times of logging in by the user, from the upper limit usage amount, when the user has logged into an information processing apparatus that executes the printing function and used the printing function.
